(19) United States
(12) Patent Application Publication
(10) Pub. No.: US 2008/0092416 A1
(43) Pub. Date: Apr. 24, 2008

(54) Viewing Device and Cardboard Blank for the Production Thereof

(76) Inventor: Oliver Heine, Oberraden (DE)

Correspondence Address: Harbin King & Klima, 500 Ninth Street, SE, Washington, DC, 20003, US

(21) Appl. No.: 10/579,999

(22) PCT Filed: Nov. 12, 2004
(86) PCT No.: PCT/DE04/02501

§ 371 Date: Jul. 5, 2007

(30) Foreign Application Priority Data
Nov. 19, 2003 (DE) 203 17 862.9

(51) Int. Cl. G09F 19/12; G09G 3/36

(52) U.S. Cl. 40/1; 345/87

(57) ABSTRACT

The invention relates to a viewing device, having a housing (2; 26) which has a front wall (3; 3′; 21; 29) with at least one viewing opening (8; 8′; 23; 28) for an object on view (10; 16; 24) that can be disposed or displayed inside the housing (2; 26) on the inner face (9; 91; 34; 51) of the back wall (4; 4′; 22; 32, 33), and to a blank (25) for producing such a viewing device. In order for the two-dimensional object on views (10; 16; 24) displayed in such a viewing device (1; 1′; 20; 27) to give a three-dimensional impression, the invention proposes embodying the outer face (100) of the front wall (3; 3′; 21; 29) of the housing (2; 26) of the viewing device (1; 1′; 20; 27) as curved toward the observer (7). The three-dimensional impression of the object on view (10; 16; 24) to be displayed can be still further enhanced if in addition the back wall (4; 4′; 22; 32, 33) of the housing (2; 26) of the viewing device (1; 1′; 20; 27) has an inner face (9; 9′; 34; 51) that is curved away from the observer (7).

### BACKGROUND OF THE INVENTION

The invention relates to a viewing device, having a housing which has a front wall with at least one viewing opening for an object on view that can be located or displayed inside the housing on the inner face of the back wall. The invention also relates to a cardboard blank for producing such a viewing device.

A viewing device of the type mentioned above is known for instance from German Utility Model DE 201 12 225 U1. This known device is composed essentially of three relatively bulky housing parts: namely, a base part serving as a stand and including a light source; a framelike front part; and a housing part on the back. The individual housing parts are preferably of stone, synthetic stone, or cast stone. To gain a three-dimensional impression, in particular of motifs that must be displayed two-dimensionally, it is already proposed in this reference that the inner face of the housing part on the back, oriented toward the observer, be provided with a curvature oriented toward the back side of the housing part.

### SUMMARY OF THE INVENTION

It is an object of the invention to disclose a viewing device, of the type mentioned at the outset, in which the three-dimensional impression of the objects on view to be displayed is achieved by alternative provisions to those of DE 201 12 225 U1. It is also an object to disclose a cardboard blank for producing a viewing device of the invention.

This object is attained according to the invention with regard to the viewing device by the characteristics of claim 1 and with regard to the blank by the characteristics of claim 29. Other particularly advantageous features of the invention are disclosed by the dependent claims.

The invention is essentially based on the concept of embodying the outer face of the front wall of the housing of the viewing device as curved toward the observer.

To still further enhance the three-dimensional impression of the object on view to be displayed, it has proved advantageous if, as already proposed in DE 201 12 225 U1, the back wall of the housing of the viewing device also has an inner face that is curved away from the observer.

The curvatures of the inner face of the back wall and the curvature of the outer face of the front wall can extend between the side edges, or between the lower and upper edges, of these faces. The corresponding curvatures may, however, also have a hemispherical course.

The specific course of curvature of the inner and outer faces depends essentially on the particular location of the observer, and on the change over time of this location with respect to the viewing device. For instance, if the user is moving relative to the device along a horizontal viewing plane or plane of motion (that is, if the observer is moving past the device), then it is practical for the curvatures of the inner and outer faces to extend between the side edges. Conversely, if an observer is moving up or down (in an elevator, for instance, or the like), then the curvatures of the inner and outer faces should also extend from the bottom upward.

It has been demonstrated that by means of a suitable location of the curvatures of the inner and/or outer faces of the housing, surprising effects can be attained, for instance for amusement parks (rides, shooting galleries, and so forth).

To produce corresponding viewing devices in a simple way, for instance by means of folding operations, it has proved practical to make the housing walls, or more particularly the back wall and the front wall, from a thin-walled material with a thickness of ≦2 mm, so that for producing the curvatures of the inner and outer faces, the entire back wall and front wall have a corresponding curvature.

In one embodiment of the invention, the back wall and the front wall of the housing are embodied in curved fashion such that they touch one another directly along their side edges. The oval peripheral region on the bottom of the back and front walls that results in this case can simultaneously serve as a face for the viewing device of the invention to stand on.

As is already known per se, the object on view should be capable of being illuminated by means of at least one light source that can be located inside the housing; in most cases, the light source is located below the viewing opening.

As the light source, small low-power incandescent bulbs (<7.5 W) can be considered. LED elements, in particular, have proved advantageous because of their low power.

The inner faces of the back and/or front wall surrounding the light source and/or diametrically opposite the light source may, particularly when they are located outside the viewing range of an observer, be embodied as reflective surfaces.

Preferably, the objects on view should be capable of being secured to the inner face of the back wall of the respective housing in such a way that their side edges are located outside the viewing range of an observer who is just at that moment looking through the viewing opening.

The objects on view need not be embodied two-dimensionally; they may also be embodied in relief, which leads to additional light and shadow effects and reinforces the plastic impression.

The two-dimensional object on view need not be “glued” to the back wall but instead can be located on the inner face of the back wall of the respective housing in such a way that in at least one portion it does not touch the inner face, since such effects also lead to more-intensive perception.

The inner face of the back wall may also include at least one securing element for releasably securing changing motifs.

The objects on view may also involve a striplike object, which is located on the coil of a winding device and can be rewound onto another coil. The coils of the winding device are then located to the left and right of the back wall, for instance, so that rewinding from one reel to the other, and viewing of the particular portion of the strip located between them is possible. So that the striplike object will follow the curvature of the back wall, a suitably shaped transparent guide plate (for instance of plexiglass) should be placed in front of it, with the striplike object extending behind it and at the same time protected.

In a further embodiment of a viewing device of the invention, a portion of the inner face of the back wall is embodied as an LCD screen, on which the object on views can then be displayed. The electronic unit required for triggering this LCD screen is preferably located inside the housing-shaped back wall of the viewing device.

In another version of the invention, a portion of the inner face of the back wall is formed by a (generally non-glare) screen, onto which objects on view can be projected from the rear.

The viewing opening of the viewing device can be protected by a transparent covering (such as a film, plexiglass, glass, or so-called one-way mirror] which becomes transparent as soon as it is lighted from behind). The covering may have a (filigreelike) imprint (writing or images), which appears to move the covering to the foreground and makes it a reference in terms of size, which reinforces the three-dimensional impression.

The housing of the viewing device of the invention may be produced from various materials (plastic, polyurethane, plexiglass, wood, sheet metal, and recycled material). Cardboard material of the kind sold by the cardboard box industry for the most various uses, such as flat material which vary in thickness, color and structure, optionally and in particular surface-treated, for instance sealed, coated, reflecting, and so forth, has proved particularly practical. When corrugated cardboard is used, it becomes possible to place movable ends, such as a closure flap, firmly against the rough surface of adjacent parts.

It has also proved especially effective if photographic reproductions on matte paper rather than high-gloss paper are used.

In a further version of the invention, the front wall of the housing is embodied cylindrically, in the manner of an advertising column, and has a plurality of viewing openings distributed over the circumference.

The viewing openings may be distributed arbitrarily, that is, either regularly or irregularly, over the circumference. The viewing openings may be located along a circumferential line that extends along the same height, or a circumferential line which rises and then falls again. Naturally, an arrangement of the viewing openings along a plurality of circumferential lines or parts of them could be made.

The back wall of the housing of the viewing device of the invention can also be designed cylindrically and can optionally be embodied as rotatable about its central longitudinal axis.

A further refinement of the concept of the invention is that the viewing device is embodied variably, namely such that the curvature of the front wall and back wall can be changed. It can begin in a flat state (the state of repose), in which the viewing device is nothing more than a card-like envelope and can be converted to a curved state (the viewing state), and its curvature—depending on the material—can be increased to the point of a cylindrical shape. This process is reversible.

The above embodiment can be realized according to the invention in that the back wall, on which an object on view is or can be located, is originally flat, as is the front wall, located in front of it, with the viewing opening for the object on view, and the front and back walls comprise flexible material (paper, cardboard, plastic film or metal foil) and are joined together along two diametrically opposed sides in such a way that they cause one another to bulge out and form a housing as soon as they are pressed together at their connecting lines.

Advantageously, the object on view can be illuminated by a light source located inside the housing, and the light source has a switch which is located in the region of the pressed-together sides and is actuatable by the pressing together.

Moreover, in this kind of variable viewing device, still other characteristics may be realized, of the kind recited above for a viewing device of fixed shape. These last embodiments are especially well suited to use as an advertising display, greeting card, or the like.

Further details and advantages of the invention will become apparent from the following exemplary embodiments described in conjunction with the drawings.

### BRIEF DESCRIPTION OF THE DRAWINGS

FIG. 1 shows the cross section through a first exemplary embodiment of a viewing device of the invention, taken along the line marked I-I in FIG. 2;

FIG. 2 is a front view of the viewing device shown in FIG. 1;

FIG. 3 shows the cross section through the back wall of a second exemplary embodiment of a viewing device of the invention, with a winding device for a striplike object on view;

FIG. 4 is a cross section through a third exemplary embodiment, designed in the form of an advertising column, of a viewing device of the invention;

FIG. 5 is a longitudinal section through a fourth exemplary embodiment of the invention, in which an LCD screen is used for displaying objects on view;

FIG. 6 shows a first cardboard blank for producing a viewing device of the invention, in the unfolded state;

FIGS. 7 and 8 show the front and back sides, respectively, of the viewing device that results once the cardboard blank shown FIG. 5 has been folded up;

FIG. 9 shows a second blank, as an insertion part for the viewing device that can be made from the blank shown in FIG. 5; and

FIG. 10 is a perspective view of a variable viewing device, in the viewing state held in the hand of an observer.

### DETAILED DESCRIPTION

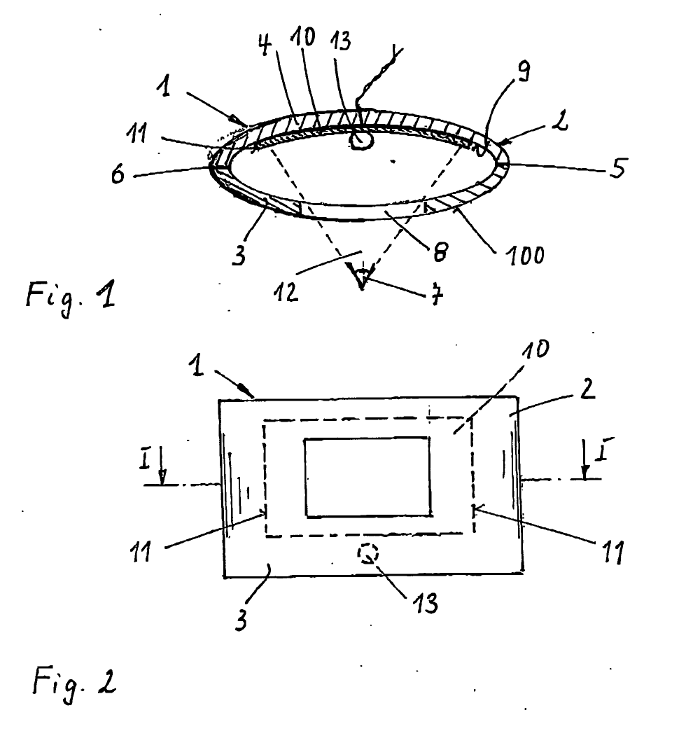

In FIGS. 1 and 2, a viewing device of the invention is identified by reference numeral 1, and it includes a housing 2, for instance of plastic, with a curved front wall 3 and a curved back wall 4 that are joined together along side edges 5, 6. The front wall 3, curved toward the observer 7, has an outer face 100 and includes a viewing opening 8, which can for instance be protected by a transparent covering (not shown).

The back wall 4 of the housing 2 has an inner face 9, curved away from the observer 7, to which a two-dimensional object on view 10 (for instance a photograph) is interchangeably secured; the side edges 11 of this object are located outside the field of view 12 of the observer 7 who is just then looking through the viewing opening 8.

The object on view 10 can be illuminated by a light source 13, located below the viewing opening 8 and secured to the back wall 4 of the housing 2.

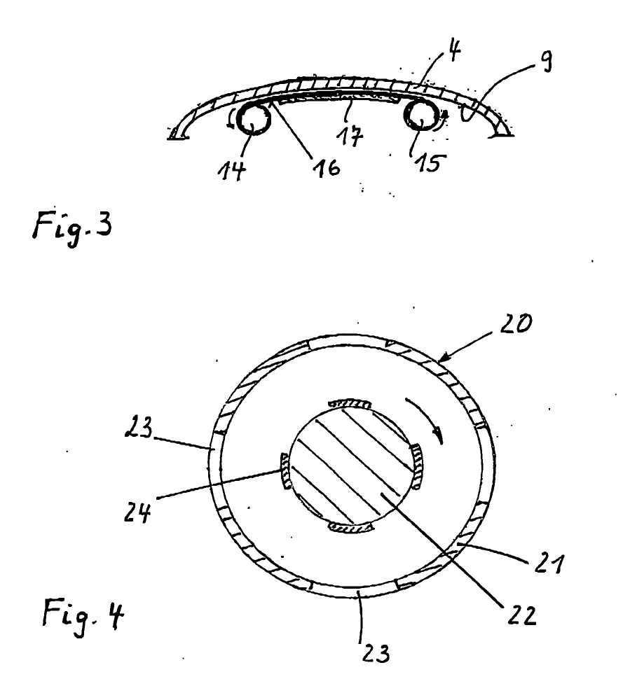

In FIG. 3, the back wall, also identified by reference numeral 4, of a second exemplary embodiment of a viewing device of the invention is shown. In this viewing device, a winding device comprising two coils 14, 15 is located on the back wall. A striplike object on view 16 can be unwound from and onto the coils 14, 15 and this object is guided between the coils 14, 15 by a transparent guide plate 17.

FIG. 4 shows the cross section through a viewing device 20 designed as an advertising column. This device substantially comprises a front wall 21, embodied as a hollow cylinder, and a rotatable back wall 22, located in the interior of the hog 21 and also embodied as a cylinder. The front wall 21 has four viewing openings 23, distributed uniformly over the circumference.

Four objects on view 24 (which are for instance interchangeable) are secured to the back wall 22 and are movable with the rotating back wall 22 past the viewing openings 23.

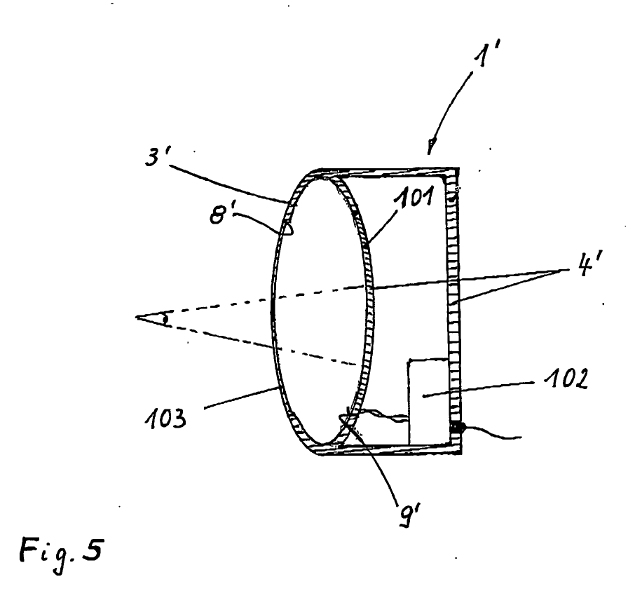

In the version of a viewing device 1′ of the invention shown in FIG. 5, a portion of the inner face 9′ of the back wall 4′ is embodied as an LCD screen 101, on which the objects on view can be displayed. The electronic unit 102 required for triggering this LCD screen 101 is located inside the housing-shaped back wall 4′ of the viewing device 1′. The viewing opening 8′ contained in the front wall 33 is closed, in the exemplary embodiment shown, by a transparent covering 103.

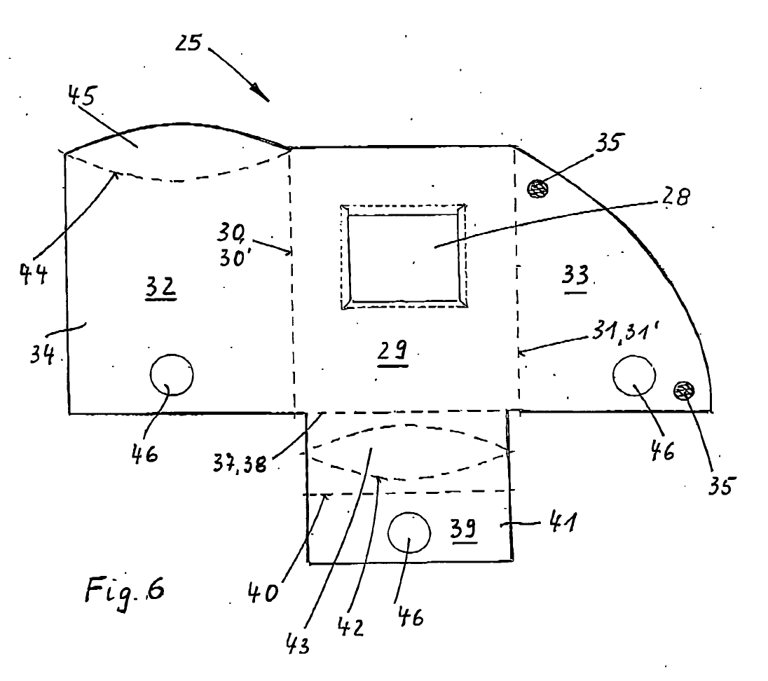

FIG. 6 shows a cardboard blank, identified by reference numeral 25, of corrugated cardboard for producing the housing 26 of a viewing device 27 of the invention, and in the folded state it has a shape (of oval cross section) that essentially corresponds to FIGS. 1 and 2. The blank 25 includes a first portion 29, provided with a viewing opening 28 and forming the front wall of the housing 26 of the viewing device 27. The two transverse sides 30, 31 of the first portion are adjoined by a second portion 32 and a third portion 33 which form the back wall of the viewing device 27, and the connecting edges 30′, 31′ of the portions 29, 32 and 29, 33 form the folding lines for folding the cardboard blank 25.

The second portion 32 includes the inner face 34 that carries the object on view (not shown), and the third portion 33 serves to reinforce and fix the second portion 32 and can be connected to it by nonpositive engagement via two hook-and-loop closure regions 35.

For forming the oval bottom region 36 of the housing 26, the first portion 29 of the blank 25 is joined at its underside 37, via a straight folding line 38, to a fourth portion 39. This fourth portion, approximately at a spacing that corresponds to the maximum spacing of the front and back walls of the housing 26 to be made, has a folding line 40, so that after the folding operation, the outer peripheral region 41 of the fourth portion 39 is braced on the second portion 32. Between the folding lines 38 and 40, an oval region 43 defined entirely by a folding line 42 is provided, which is selected such that after the folding operation, the oval bottom region 36 is the result, which is recessed somewhat compared to the lower edges of the front and back sides of the housing.

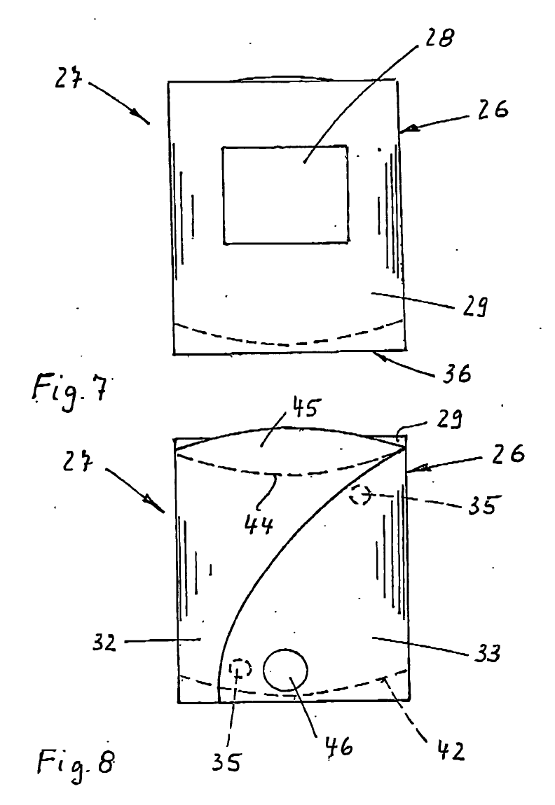

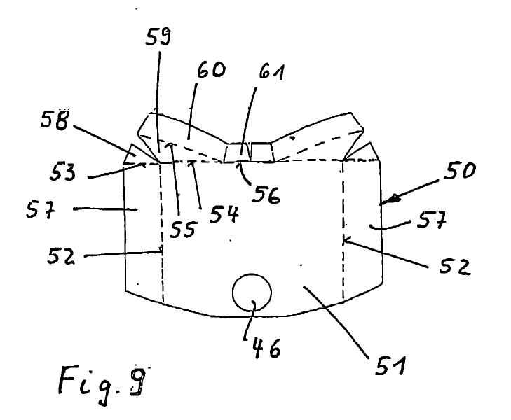

As can be seen from FIG. 6, the second portion 32 is defined at the top by an oval region 45, which is defined by a folding line 44 and which in the folded state of the blank forms the top region of the housing, in such a way that the top region 45 rises slightly obliquely from the back wall 32, 33 to the front wall 29 (FIG. 8).

In each of the second, third and fourth portions 32, 33 and 39, there is also a respective opening 46 through which a lamp socket (not shown) can be passed partway, so that in the folded state of the blank, the lamp socket can be screwed to a nut part (not shown), for instance toward the lamp, and the three portions 32, 33 and 39 are held together not only by the hook-and-loop closure regions 35, but also and above all by the lamp socket.

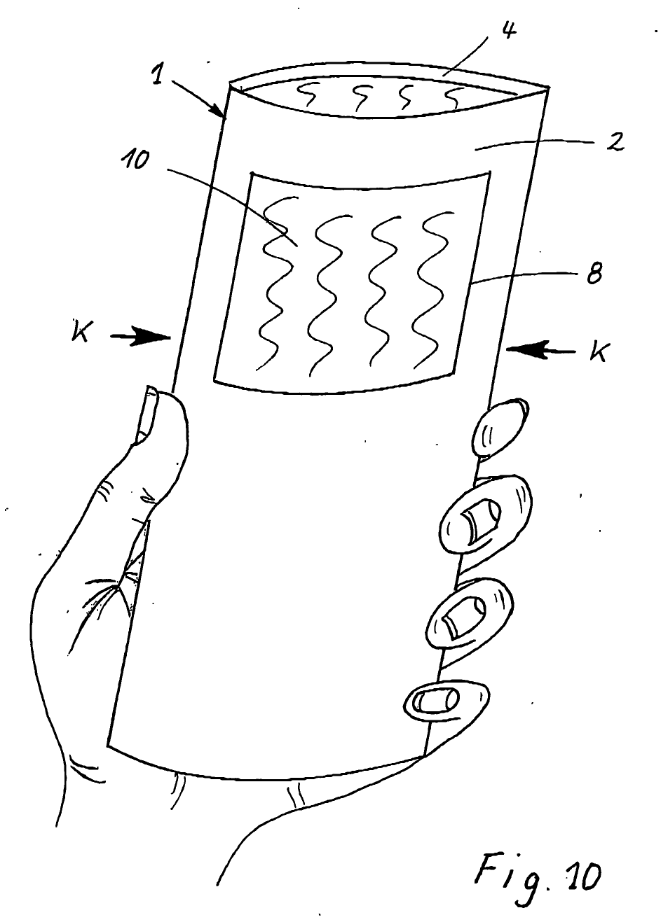

To enable quickly replacing an object on view and to enable varying the curvature of the inner face of the back wall, an additional insertion part may be used, which is braced on the second portion of the blank via suitable peripheral support regions. A corresponding blank for this insertion part can be found in FIG. 9 and is identified by reference numeral 50. The inner face is identified there by reference numeral 51, and the bracing regions, offset via folding lines 52-56, are identified by reference numerals 57-61. This insertion part 50, too, can be joined by nonpositive engagement to the three portions 12, 33 and 39 of the first blank 25 via the aforementioned lamp socket and likewise has an opening 46 for this purpose.

Finally, in FIG. 10, a variable viewing device 1 is also shown which originally had the form of a two-dimensional card-like envelope, but which in the observer's hand, by being pressed together at the connecting lines of the front and back walls 3, 4, has been converted from an originally flat state (the state of repose) to a viewing state, Both the front and back walls 3, 4 are made to bulge out in the process and together form a housing 2, with the effects that have already been described above for viewing devices with a fixed housing. For maintaining the viewing state shown, a persistent exertion of force is needed, as symbolized by the arrows K. Other viewing states (as a consequence of greater or lesser curvature) can be established by changing (increasing/lessening) the force expended.

### LIST OF REFERENCE NUMERALS

1, 1′ Viewing device
2 Housing
3, 3′ Front wall
4, 4′ Back wall
5, 6 Side edges
7 Observer
8, 8′ Viewing opening
9, 9′ Inner face
10 Object on view
11 Side edges (of object on view)
12 Field of view
13 Light source
14, 15 Coils
16 Object on view
17 Guide plate
20 Viewing device
21 Front wall, hollow cylinder
22 Back wall
23 Viewing opening
24 Object on view
25 (First) blank, cardboard blank
26 Housing
27 Viewing device
28 Viewing opening
29 First portion, front wall
30, 31 Transverse sides
30′, 31′ Connecting edges, side edges
32 Second portion, back wall
33 Third portion, back wall
34 Inner face
35 Hook-and-loop closure region
36 Bottom region
37 Underside
38 Folding line
39 Fourth portion
40 Folding line
41 Peripheral region
42 Folding line
43 Oval region
44 Folding line
45 Oval region, top region
46 Opening
50 (Second) blank
51 Inner face
52-56 Folding lines
57-61 Bracing regions
100 Outer face
101 LCD screen
102 Electronic unit
103 Transparent covering
K Arrow, force arrow

1) A viewing device, having a housing (2; 26) which has a front wall (3; 3′; 21; 29) with at least one viewing opening (8; 8′; 23; 28) for an object on view (10; 16; 24) that can be disposed or displayed inside the housing (2; 26) on the inner face (9; 9′; 34; 51) of the back wall (4; 4′; 22; 32, 33), characterized in that the front wall (3; 3′; 21; 29) of the housing (2; 26) has an outer face (100). that is curved toward the observer (7).

2) The viewing device as defined by claim 1, characterized in that the back wall (4; 4′; 22; 32, 33) of the housing (2; 26) has an inner face (9; 9′; 34; 51) that is curved away from the observer (7).

3) The viewing device as defined by claim 2, characterized in that the curvatures of the inner face (9; 9′; 34; 51) of the back wall (4; 4′; 22; 32, 33) and the curvature of the outer face (100) of the front wall (3; 3′; 21; 29) extend between the two side edges of the corresponding faces, or between the lower and upper edges of those faces.

4) The viewing device as defined by claim 2, characterized in that the curvatures of the inner face of the back wall and the curvature of the outer face of the front wall have a hemispherical course.

5) The viewing device as defined by claim 2, characterized in that the back wall (4; 22; 32, 33) has a curvature corresponding to its inner face (9; 34), and the front wall (3; 21; 29) has a curvature corresponding to its outer face (100).

6) The viewing device as defined by claim 5, characterized in that the back wall (4; 32, 33) and the front wall (3; 29) of the housing (2; 26) are embodied in curved form in such a way that they touch one another directly along their side edges (3, 6; 30′, 31).

7) The viewing device as defined by claim 1, characterized in that the object on view (10; 16; 24) can be illuminated by means of at least one light source (13) that can be located inside the housing (2; 26).

8) The viewing device as defined by claim 7, characterized in that the light source (13) is located below the viewing opening (8; 23; 28).

9) The viewing device as defined by claim 7, characterized in that the light source (13) is an electrical light source that can be secured to the back wall (4; 22; 32, 33) of the housing (2; 26).

10) The viewing device as defined by claim 9, characterized in that the electrical light sources (13) are LED elements.

11) The viewing device as defined by claim 1, characterized in that the inner faces of the back wall (4; 22; 32, 33) and/or front wall (3; 21; 29), surrounding the light source (13) and/or diametrically opposite the light source (13) are embodied as reflective surfaces.

12) The viewing device as defined by claim 1, characterized in that the objects on view (10) can be secured to the inner face (9) of the back wall (4) of the respective housing (2) in such a way that their side edges (11) are located outside the field of view (12) of an observer (7) looking straight through the viewing opening (8).

13) The viewing device as defined by claim 1, characterized in that objects on view (10; 16; 24) can be located on the inner face (9; 34; 51) of the back wall (4; 22; 32, 33) of the respective housing (2; 26) in such a way that they do not touch one another, in at least a portion of the inner face (9; 34; 51).

14) The viewing device as defined by claim 1, characterized in that the inner face (9; 34; 51) of the back wall (4; 22; 32, 33) has at least one securing element for releasably securing changing motifs.

15) The viewing device as defined by claim 2, characterized in that on the back wall (4) of the housing, a winding device including two coils (14, 15) and a transparent guide plate (17), located in the field of view of the observer (7) and following the curvature of the inner face (9) of the back wall (4) but spaced apart from it, are located in such a way that a striplike object on view (16) located on the winding device can be moved between the guide plate (17) and the inner face (9).

16) The viewing device as defined by claim 1, characterized in that the housing (2; 26) comprises a cardboard material, plastic, or sheet metal.

17) The viewing device as defined by claim 16, characterized in that the housing (2; 26) comprises a corrugated cardboard material.

18) The viewing device as defined by claim 1, characterized in that the viewing device (1; 20; 27), for the sake of its intended use is designed movably, in particular displaceably, rotatably, and/or drivably.

19) The viewing device as defined by claim 1, characterized in that the viewing opening (8; 23; 28) of the front wall (3; 21; 29) is protected by a transparent covering.

20) The viewing device as defined by claim 1, characterized in that the front wall (21) of the housing is embodied cylindrically and has a plurality of viewing openings (23) distributed over the circumference.

21) The viewing device as defined by claim 20, characterized in that the viewing openings (23) are located on a circumferential line that runs around at the same height, or rises or falls.

22) The viewing device as defined by claim 2, characterized in that the back wall (22) is likewise embodied cylindrically.

23) The viewing device as defined by claim 21, characterized in that the back wall (22) is supported rotatably about its central longitudinal axis.

24) The viewing device as defined by claim 2, characterized in that at least a portion of the inner face (9′) of the back wall (4′) is embodied as an LCD screen (101), on which corresponding objects on view can be displayed.

25) The viewing device as defined by claim 24, characterized in that the electronic unit (102) required for triggering the LCD screen (101) is located inside a back wall (4), embodied as housing-shaped, of the viewing device (1′).

26) The viewing device as defined by claim 1, characterized in that at least a portion of the inner face of the back wall is formed by a screen, onto which objects on view can be projected from the rear.

27) The viewing device as defined by claim 1, characterized in that the back wall (4), on which an object on view (10) is or can be located, is originally flat, as is the front wall (3), located in front of it, with the viewing opening (8) for the object on view (10), and the front and back walls (3, 4) comprise flexible material (paper, cardboard, plastic film or metal foil) and are joined together along two diametrically opposed sides in such a way that they cause one another to bulge out and form a housing (2) as soon as they are pressed together at their connecting lines.

28) The viewing device as defined by claim 27, characterized in that the object on view (10) can be illuminated by a light source (13) located inside the housing (2), and the light source has a switch which is located in the region of the pressed-together sides and is actuatable by the pressing together.

29) A cardboard blank for producing a viewing device as defined by claim 6, characterized in that the blank (25) has a first portion (29), provided with a viewing opening (28) and forming the front wall, and two second and third portions (32, 33), adjoining the transverse sides (30, 31) of the first portion (29), and the connecting edges. (30′, 31′) of the portions form the folding lines for folding the cardboard blank; and that the second and third portions (32, 33) form the back wall of the housing, the second portion (32) including the inner face (34) that carries the object on view, and the third portion being connectable to the second portion (32) by nonpositive engagement for the sake of fixation and reinforcement of the second portion (32).

30) The cardboard blank as defined by claim 29, characterized in that the underside (37) of the first portion (29) is connected via a folding line (38) to a fourth portion (39), which includes an oval region (43) entirely defined by a folding line (42), such that the oval region (43), in the folded state, forms the bottom region of the housing (26), which is recessed somewhat compared to the lower edges of the front and back sides of the housing (26).

31) The cardboard blank as defined by claim 29, characterized in that the second portion (32) is closed off at the top with an oval region (45) defined by a folding line (44), which region, in the folded state of the blank (25), forms the top region of the housing (26), in such a way that the top region (45) rises slightly obliquely from the back wall (32, 33) to the front wall (29).

32) The cardboard blank as defined by claim 30, characterized in that in the second, third and fourth portions (32, 33, 39), openings (46) for a lamp socket are provided, which are located such that in the folded state of the blank (25), the lamp socket can be passed at least partway through all three openings (46) and screwed together toward the lamp with a nut part, so that the three portions (32, 33, 39) are held together by the lamp socket,

33) The cardboard blank as defined by claim 29, characterized in that a second blank (50) is provided, which can be located as an insertion part on the inside in front of the back wall (32, 33) of the housing (26), as a carrier for the particular object on view.
